(19) United States
(12) Patent Application Publication
(10) Pub. No.: US 2015/0199217 A1
(43) Pub. Date: Jul. 16, 2015

(54) ENTROPY RESOURCE ALLOCATION MANAGEMENT IN VIRTUALIZED ENVIRONMENTS

(71) Applicant: Cisco Technology, Inc., San Jose, CA (US)

(72) Inventors: Sonu Shankar, San Jose, CA (US); Anthony Grieco, Wake Forest, NC (US); Ashit Vora, Fairfax, VA (US)

(73) Assignee: Cisco Technology, Inc., San Jose, CA (US)

(21) Appl. No.: 14/155,071

(22) Filed: Jan. 14, 2014

(51) Int. Cl. G06F 9/50; G06F 9/455

(52) U.S. Cl. CPC G06F 9/5011; G06F 9/45533

(57) ABSTRACT

A virtual machine monitor can be enhanced to provide entropy resource management in a virtualized environment. The VM monitor can obtain entropy from an entropy source to fill an entropy bank. The VM monitor can also distribute entropy symbols from the entropy bank to VM guests in a manner that ensures VM isolation. That is, when a first VM guest requests one or more entropy symbols, the VM monitor reads the requested number of entropy symbols from the entropy bank and deletes the read entropy symbols from the entropy bank so that upon a subsequent request by the first VM guest or a request from a second VM guest fresh entropy symbols will be read from entropy bank.

### TECHNICAL FIELD

The present technology pertains to resource allocation in virtualized environments, and more specifically pertains to entropy virtualization and management in virtualized environments.

### BACKGROUND

Virtualized environments provide multiple users with access to a single physical resource, such as CPU cycles, a network connection, or memory through a virtual machine (VM) guest. To accomplish this, the virtualized environment includes a VM monitor that manages physical resource allocation across the VM guests. This is advantageous in that a VM guest requires little or no knowledge of the underlying hardware and yet the VM guest can perform computing tasks as if the VM guest has full access to all physical resources. Unfortunately, this layer of abstraction/virtualization creates challenges when implementing security services using cryptography.

A key piece of any cryptographic solution is random number generation. Both hardware and software random number generators exist, each with positive and negative features. Hardware-based true random number generators involve the sampling and digitization of electronic noise that can serve as seed values possessing high entropy for pseudorandom number generators, which are typically implemented in software. Hardware-based random number generators are highly secure because they produce an output that is usually statistically independent and unpredictable. However, hardware random number generation is slow, which prohibits use in many situations. For example, network switches can require large quantities of random numbers at frequent intervals, which cannot be satisfied by some hardware random number generators. Software random number generators are designed for simplicity and performance, making random number generation fast. However, while capable of being cryptographically secure, software random number generators are deterministic because the sequence is based on a seed value. To create a cryptographically secure sequence a software random number generator seed value must possess high entropy and be re-seeded at periodic intervals. A way to accomplish this is to use a hardware source for the seed value.

In a non-virtualized environment, a hardware source of entropy is generally available. However, even in cases where good entropy sources exist in the underlying physical platform, providing access to it in the virtual environment is non-trivial and a VM guest is required to have knowledge of the specific hardware-based noise source. If there is more than one hardware-based noise source, the VM guest has to known about them, know about the quality of the source, and then somehow negotiate with other VM guests to access the hardware resources, which may be prohibited by the VM monitor. Alternatively, a VM guest can obtain entropy through alternative hardware components like special USB tokens, but these types of components are not accessible across VM guests.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary virtualized environment;

FIG. 2 illustrates an exemplary technique of obtaining entropy for storage in an entropy bank;

FIG. 3A illustrates an exemplary entropy bank fill scenario based on crossing a predefined minimum amount of entropy;

FIG. 3B illustrates an exemplary entropy bank fill scenario based on fill after completing entropy request.

FIG. 4 illustrates an exemplary request for entropy by two VM guests;

FIG. 5 illustrates an exemplary method embodiment for entropy virtualization; and

FIGS. 6A and 6B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

The disclosed technology addresses the need in the art for virtualized entropy and entropy resource management in virtualized environments. In an embodiment, to provide virtualized entropy and entropy resource management, a system receives a request for entropy from a virtual machine guest. In response to the request, the system reads one or more entropy symbols from an entropy bank common to one or more virtual machine guests. After reading the one or more entropy symbols from the entropy bank, the system sends the one or more entropy symbols to the requesting virtual machine guest.

In another embodiment, to provide virtualized entropy and entropy resource management, a virtualized environment obtains entropy from an entropy source and stores the entropy in an entropy bank common to one or more virtual machine guests. At some point, the virtualized environment receives a first request for entropy from a first virtual machine guest, and in response to the request, the virtualized environment reads one or more entropy symbols from the entropy bank. After reading the one or more entropy symbols, the virtualized environment sends the one or more entropy symbols to the first virtual machine guest.

### Virtualized Entropy and Entropy Resource Management

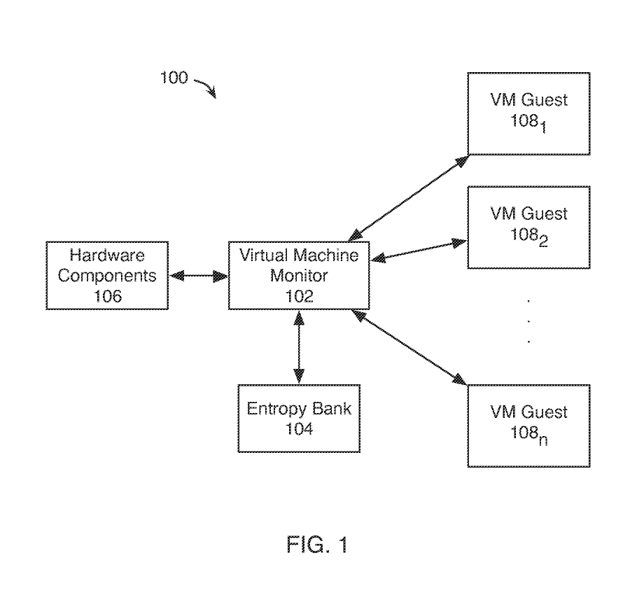

Virtualized environments provide multiple users with access to a single physical resource, such as CPU cycles, a network connection, or memory, through a virtual machine (VM) guest. FIG. 1 illustrates exemplary virtualized environment 100. Virtualized environment 100 includes virtual machine monitor 102 that manages physical resource allocation of hardware components 106 across VM guests 108₁, 108₂, . . . , 108ₙ (collectively “108), which may be running different operating systems.

Virtualized environment 100 can be enhanced to address the limitations described above, which make it difficult to implement a cryptographically secure software-based random number generator in a virtualized environment. In particular, virtualized environment 100 can include entropy bank 104 that can store entropy, such as one or more entropy symbols, for use by VM guests 108. VM monitor 102 can manage entropy bank 104 by both obtaining entropy to fill entropy bank 104 and distribute entropy from entropy bank 104 to VM guests 108 in a manner that ensures VM isolation. That is, when VM guest 108ᵢ requests a certain amount of entropy, such as one or more entropy symbols, VM monitor 102 reads the requested amount of entropy from entropy bank 104 and deletes the read entropy symbols from entropy bank 104 so that in response to a subsequent request by VM guest 108ᵢ or another VM guest 108ⱼ, VM monitory 102 obtains fresh entropy symbols from entropy bank 104.

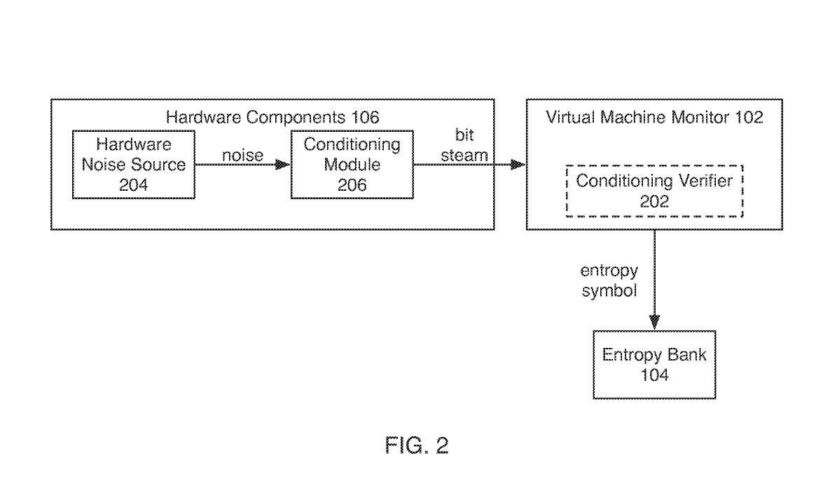

As described above, VM monitor 102 can be configured to obtain entropy and store it to entropy bank 104. FIG. 2 illustrates an exemplary technique of obtaining entropy for storage in an entropy bank. VM monitor 102 can communicate with hardware components 106 to obtain a conditioned bit stream. Hardware components 106 can include hardware noise source 204 that produces noise. Hardware components 106 can also include conditioning module 206 that can take the produced noise and condition the noise using an algorithm such as NIST 800-90 to generate a bit stream with appropriate statistical properties for use as entropy. Additionally, hardware components 106 can include a special purpose processor instruction designed to make a bit sequence or one or more entropy symbols available upon execution. For example, hardware components 106 can include the RdRand instruction from the Intel™ Ivy Bridge processor. In another example, VM monitor 102 can obtain an entropy bit stream from other sources like/dev/random. The special purpose instruction or other source of entropy can be in addition to one or more hardware noise sources. In this case, VM monitor 102 can manage the multiple sources to ensure they co-exist and are all made available as sources of entropy across all VM guests 108.

In some cases, the bit stream or bit sequence obtained by VM monitor 102 may not be appropriately conditioned. Accordingly, VM monitor 102 can include an optional conditioning verifier 202. VM monitor 102 can apply conditioning verifier 202 to ensure that the bit stream is appropriately conditioned and unbiased. If the verification check fails, VM monitor 102 can condition the raw bits.

The bit stream is usually received as a series of entropy symbols. An entropy symbol can be of any width, e.g., 1 bit, 3 bits, 8 bits, etc., and can be based on the physical characteristics of the underlying noise. Once VM monitor 102 has obtained one or more entropy symbols, VM monitor 102 can save the one or more entropy symbols to entropy bank 104. Based on requests received from the consuming guest application, an appropriate amount of entropy can be distributed.

Entropy bank 104 can be configured as any data storage structure that supports reading data from and writing data to the entropy bank. For example, entropy bank 104 can be configured as a first-in-first-out (FIFO) queue. A FIFO queue supports efficient reads and writes and makes it easy to maintain a count of a current number of entropy symbols in the bank. Other structures could also be used, such as first-in-last-out (FILO) stack. Entropy bank 104 can also be configured to be of any size. In some cases, the maximum amount of entropy can be based on a number of connected VM guests. In this case, the size of entropy bank 104 can dynamically change as VM guests connect and disconnect.

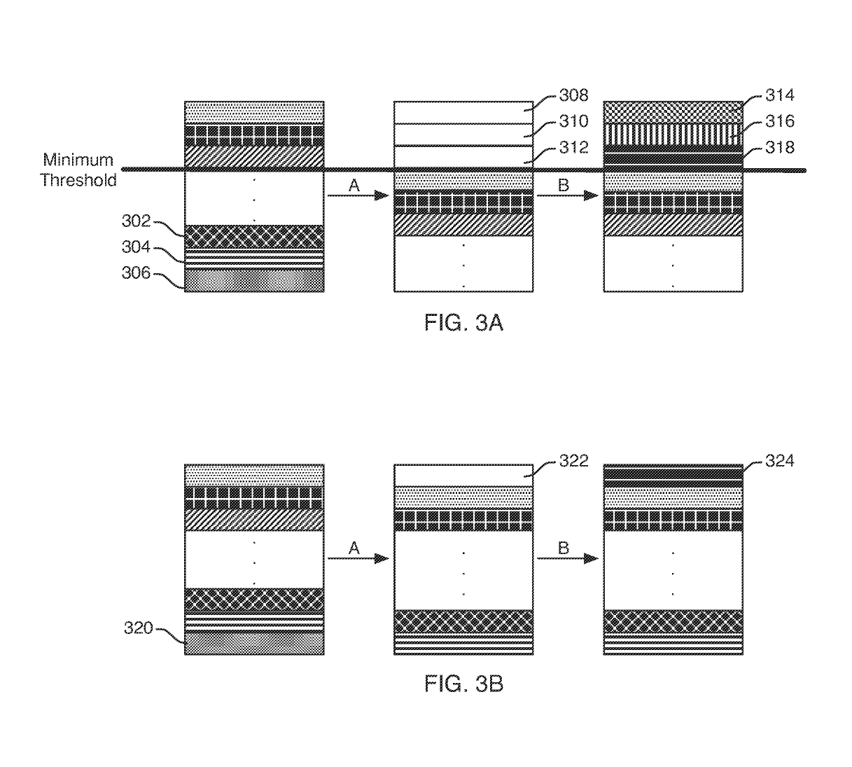

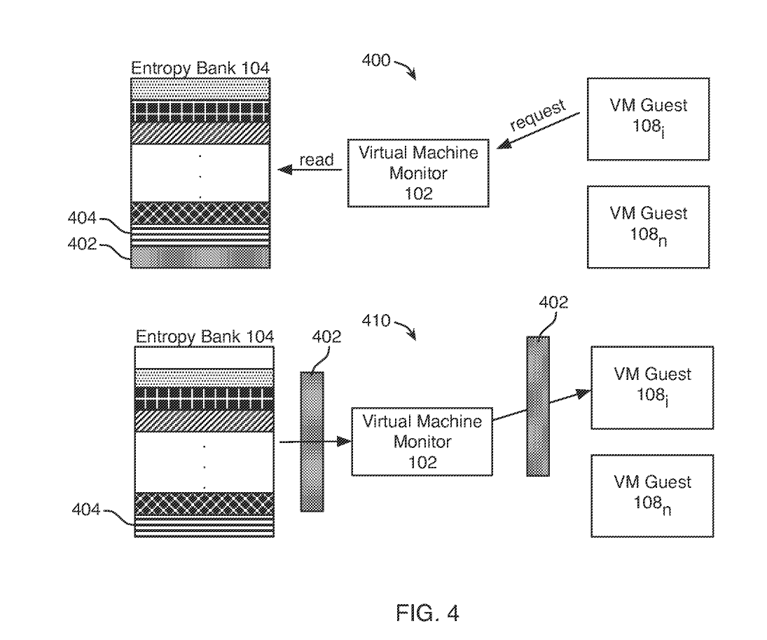

VM monitor 102 can be configured to support different entropy bank fill models. A first fill model can store new entropy to entropy bank 104 when a number of remaining amount of entropy decreases to a minimum threshold number of bits or symbols. When the minimum is reached or crossed, VM monitor 102 can obtain new entropy and store it in entropy bank 104 until entropy bank 104 is full. FIG. 3A illustrates an exemplary entropy bank fill scenario where the VM monitor is configured to fill when a minimum amount number of entropy has been reached or crossed. Initially, the entropy bank is full of entropy. Then at step A three entropy symbols 302, 304, 306 are removed from the entropy bank, leaving three empty slots 308, 310, 312. The entropy symbols could have been removed as a result of a single request or a sequence of requests. After the third entropy symbol has been removed the VM monitor detects that the minimum fill level has been reached. In response to detecting the fill trigger, at step B the VM monitor obtains new entropy to fill symbols 314, 316, 318 and stores it in the entropy bank to restore the entropy bank to full capacity.

A second fill model can store new entropy to entropy bank 104 after completing a request from a VM guest for one or more entropy symbols. In this model, for every entropy symbol removed to satisfy a request form a VM guest, the VM monitor obtains new entropy and stores it to the entropy bank. This ensures that after every request is satisfied the entropy bank is returned to full capacity. FIG. 3B illustrates an exemplary entropy bank fill scenario where the VM monitor is configured to re-fill after every request from a VM guest. Initially, the entropy bank is full of entropy. Then at step A, VM monitor processes a request for a single entropy symbol from a VM guest by removing entropy symbol 320, leaving empty slot 322. After completing the request, the VM monitor at step B replaces the single entropy symbol by obtaining new entropy for entropy symbol 324 and stores it in the entropy bank to restore the entropy bank to full capacity. If the request had been for multiple entropy symbols, VM monitor would have read all of the requested entropy symbols prior to refilling the entropy bank.

A third fill model can continuously store new entropy to entropy bank 104. In this case, once an entropy symbol has been read the VM monitor obtains new entropy to ensure that the entropy bank is always at full capacity. Using this fill model the VM monitor does not necessarily wait until a VM guest's request has been fully satisfied to re-fill the entropy bank.

VM monitor can be configured to support additional fill models including fill models based on a combination of the three fill models described above.

When VM monitor 102 receives a request for entropy from VM guest 108ᵢ, VM monitor 102 reads one or more entropy symbols from entropy bank 104. The VM monitor read is more than a simple read. VM monitor 102 (1) reads a number of entropy symbols required to satisfy the request, (2) removes the read entropy symbols from entropy bank 104, and (3) sends the read entropy symbols to requesting VM guest 108ᵢ. Step (2) removing the read entropy symbols is an important step because it ensures that a request form another VM guest 108j or a subsequent request from VM guest 108i will receive independent entropy symbols, thus providing VM isolation. In this case, independent means the entropy symbols are different. For example, the entropy symbols correspond to a different sequence of bits in the bit stream.

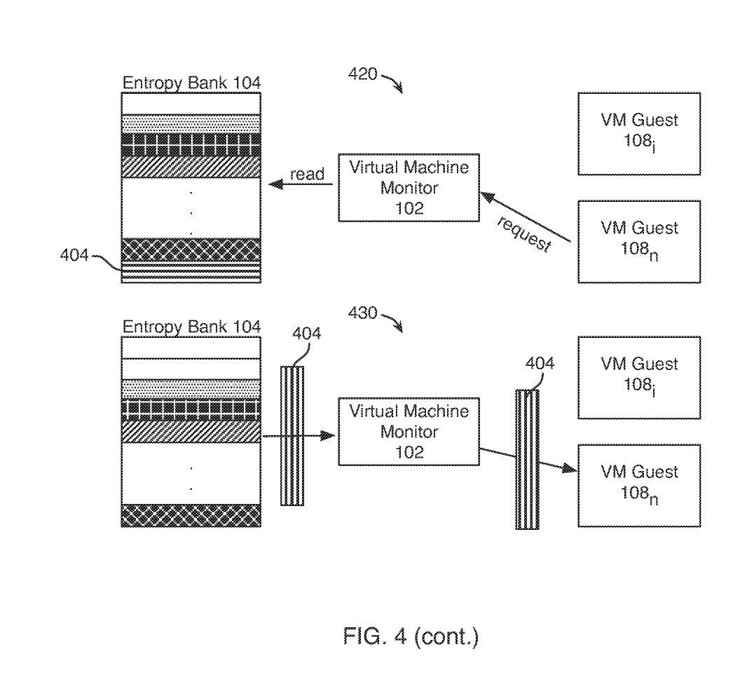

FIG. 4 illustrates an exemplary request for entropy by two VM guests. Initially at 400, VM guest 108ᵢ sends an entropy request to VM monitor 102, which reads from entropy bank 104. At 410, VM monitor 102 satisfies the request from VM guest 108ᵢ by returning entropy symbol 402, which has been removed from entropy bank 104. After receiving the entropy request from VM guest 108ᵢ at 420, VM monitor 102 receives an entropy request from a second VM guest 108ₙ. At 430, VM monitor 102 satisfies the request from VM guest 108ₙ by returning entropy symbol 404, which has been removed from entropy bank 104 and is independent from entropy symbol 402 returned to VM guest 108ᵢ.

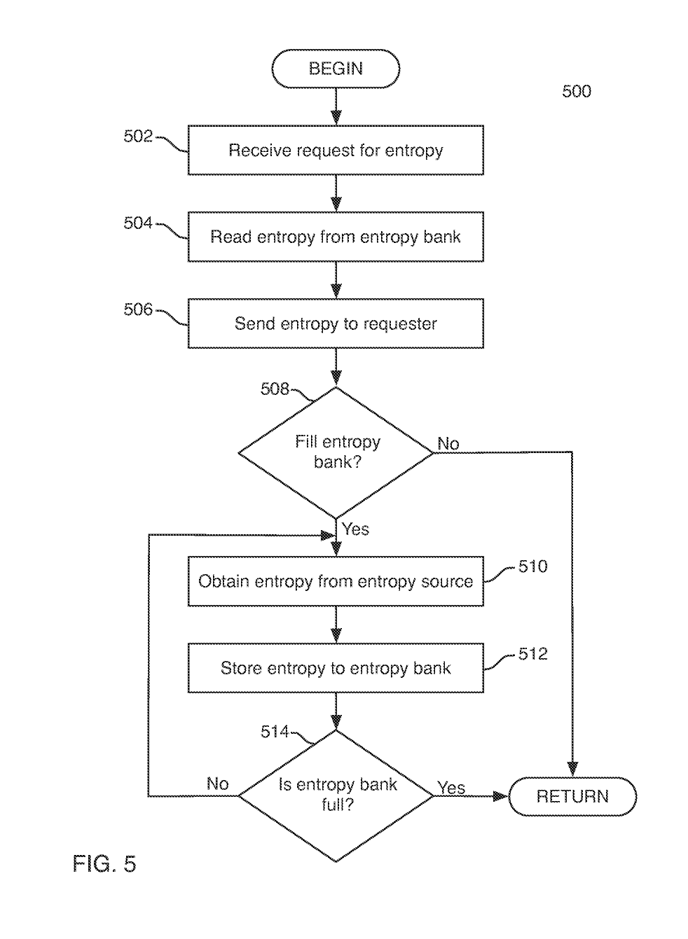

FIG. 5 is a flowchart illustrating steps in exemplary method 500 for entropy virtualization. For the sake of clarity, this method is discussed in terms of exemplary virtualized environment 100 in FIG. 1. Although specific steps are shown in FIG. 5, in other embodiments a method can have more or less steps.

At some point, VM monitor 102 can receive an entropy request from a VM guest or other process (502). In some cases, the entropy request can be triggered by a seed event on the VM guest, such as a seed event for a software random number generator running on the VM guest. The seed event can occur as the result of a provision of a new VM, a VM restart, a VM migration, or a periodic re-seeding.

In response to the entropy request, VM monitor 102 can read a bit stream of requested length, which can be one or more entropy symbols, from entropy bank 104 (504). As part of the read, VM monitor 102 reads a number of bits required to satisfy the request from entropy bank 104 and removes the read entropy bits from entropy bank 104. Removing the read entropy bits from the entropy bank ensures that a request from another VM guest or subsequent request from the VM guest will receive independent entropy symbols, thus providing VM isolation. After reading the bit stream of requested length from entropy bank 104, VM monitor 102 sends the entropy bits to the requesting VM guest (506).

Once VM monitor 102 has satisfied the entropy request from the VM guest, VM monitor 102 checks if entropy bank 104 should be filled (508). Whether a fill is required first depends on the fill model used in VM monitor 102. For example, if the fill model is fill after every request then after a request VM monitor 102 will always determine that entropy bank 104 should be filled. However, if crossing a minimum fill threshold triggers the fill, then VM monitor 102 must also check the current capacity of entropy bank 104. If VM monitor 102 determines that entropy bank 104 should be filled, VM monitor 102 obtains fresh entropy from an entropy source (510). As described above, there are a number of ways VM monitor 102 can obtain entropy from an entropy source. Once VM monitor 102 obtains entropy, VM monitor 102 stores the entropy in entropy bank 104 (512).

After storing new entropy to entropy bank 104, VM monitor 102 checks if entropy bank 104 is full (514). If not, VM monitor 102 repeats the steps of obtaining fresh entropy and storing it in entropy bank 104. If entropy bank 104 is full, or a fill was not necessary at step 508, then VM monitor 102 can resume previous processing, which can include repeating method 500.

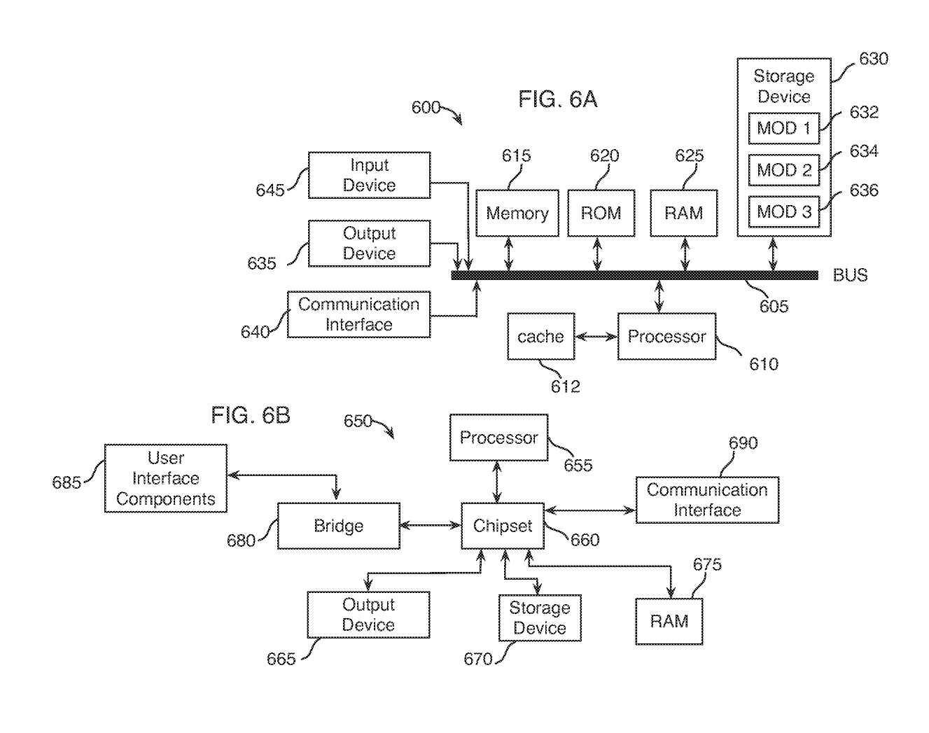

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, workstations, laptops, smart phones, small form factor personal computers, personal digital assistants, routers and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A system comprising:
at least one processor;
an entropy bank common to one or more virtual machine guests; and
a virtual machine monitor configured to provide virtual machine isolation of entropy by controlling the at least one processor to:
receive a request for entropy from a virtual machine guest;
read one or more entropy symbols from the entropy bank; and
send the one or more entropy symbols to the virtual machine guest.

2. The system of claim 1, wherein the virtual machine monitor is further configured to control the at least one processor to:
obtain at least one entropy symbol from an entropy source; and
write the at least one entropy symbol to the entropy bank.

3. The system of claim 2, wherein the virtual machine monitor obtains the at least one entropy symbol from at least one of:
a hardware noise source, or
executing a hardware instruction designed to make the at least one entropy symbol available.

4. The system of claim 1, wherein the request from a virtual machine guest is triggered by a seed event on the virtual machine guest.

5. The system of claim 4, wherein the seed event is at least one of a provision of a new virtual machine, a virtual machine restart, a virtual machine migration, or a re-seeding request from a virtual machine guest.

6. The system of claim 1, wherein reading one or more entropy symbols from the entropy bank includes removing the one or more entropy symbols from the entropy bank.

7. The system of claim 2 further comprising:
conditioning the one or more entropy symbols.

8. The system of claim 1, wherein the one or more entropy symbols are used to seed a software random number generator.

9. A computer-implemented method comprising:
obtaining entropy from an entropy source;
storing the entropy in an entropy bank common to one or more virtual machine guests;
in response to receiving a first request for entropy from a first virtual machine guest, reading a first one or more entropy symbols from the entropy bank; and
sending the first one or more entropy symbols to the first virtual machine guest.

10. The computer-implemented method of claim 9 further comprising:
in response to a second request for entropy from a second virtual machine guest, reading a second one or more entropy symbols from the entropy bank, wherein the second one or more entropy symbols are independent from the one or more entropy symbols from the first one or more entropy symbols; and
sending the second one or more entropy symbols to the second virtual machine guest.

11. The computer-implemented method of claim 9, wherein reading one or more entropy symbols from the entropy bank comprises:
removing the one or more entropy symbols from the entropy bank.

12. The computer-implemented method of claim 9 further comprising:
after reading the first one or more entropy symbols, obtaining fresh entropy from the entropy source; and
storing the fresh entropy in the entropy bank.

13. The computer-implemented method of claim 12, wherein obtaining fresh entropy occurs in response to detecting an amount of entropy in the entropy bank has reached a predefined minimum amount of entropy.

14. The computer-implemented method of claim 9, wherein obtaining entropy from an entropy source comprises:
obtaining noise from a physical noise source;
conditioning the noise to produce a bit stream; and
reading a number of bits from the bit stream for each entropy symbol in the entropy.

15. The computer-implemented method of claim 9, wherein the entropy bank is a first-in-first-out queue.

16. One or more computer readable storage media encoded with software comprising computer executable instructions and when executed operable to:
receive a request for entropy from a process;
read at least one entropy symbol from an entropy bank common to one or more processes, wherein reading the at least one entropy symbol includes removing the at least one entropy symbol from the entropy bank; and
send the at least one entropy symbol to the process.

17. The one or more computer readable storage media of claim 16 further operable to:
fill the entropy bank with at least one entropy symbol obtained from an entropy source.

18. The one or more computer readable storage media of claim 17, wherein filling the entropy bank occurs in response to at least one of:
detecting an amount of entropy in the entropy bank has decreased to at least a predefined minimum amount of entropy, or
reading the at least one entropy symbol from the entropy bank.

19. The one or more computer readable storage media of claim 17, wherein the entropy source is a hardware-based noise source and the at least one entropy symbol is conditioned prior to being written to the entropy bank.

20. The one or more computer readable media of claim 16, wherein the process is a virtual machine guest and the at least one entropy symbol is used by the virtual machine guest to seed a software-based random number generator.
